(19) United States
(12) Patent Application Publication
(10) Pub. No.: US 2024/0198825 A1
(43) Pub. Date: Jun. 20, 2024

(54) EV Charger Holder with Charger Gun Plug-in from Left or Right Direction

(71) Applicant: Computime Limited, Hong Kong (HK)

(72) Inventors: Wai Yin Shum, Hong Kong (HK); Chi Shing Ho, Hong Kong (HK); Da Xian He, Shenzhen (CN)

(21) Appl. No.: 18/483,102

(22) Filed: Oct. 9, 2023

Related U.S. Application Data
(60) Provisional application No. 63/387,754, filed on Dec. 16, 2022.

(51) Int. Cl. B60L 53/30

(52) U.S. Cl. CPC B60L 53/30

(57) ABSTRACT

An EV charger connector holder includes a housing with a base and cover and at least one removable socket plug. The housing includes a first opening and a second opening. The base includes a base plate, a first base plug-holding structure, and a second base plug-holding structure. The cover includes a first cover plug-holding structure and a second cover plug-holding structure. When the base and the cover are attached, the first base plug-holding structure and the first cover plug-holding structure form a first housing port at the first opening and the second base plug-holding structure and the second cover plug-holding structure form a second housing port at the second opening. The removable socket plug includes an outside structure adapted for fixation to the first housing port or the second housing port and an inside structure adapted for receiving and locking to a first type of electrical connector.

### RELATED APPLICATIONS

This application claims the benefit of U.S. Provisional Patent Application Serial No. 63/387,754, filed on Dec. 16, 2022, the content of which is incorporated by reference herein in its entirety.

### FIELD

The teachings herein relate to an apparatus for holding a connector or gun of a charger, a charge point, or an electric vehicle supply equipment (EVSE) device that is used to supply electric power for charging an electric vehicle (EV) when the connector or gun is not in use. More particularly, the teachings herein relate to an apparatus that accepts insertion of the connector of the EV charger from either left or right direction, allows the sockets that accept the connector of the apparatus to be interchangeable so that different types of connectors can be used, and includes a self-locking mechanism in each interchangeable socket.

### INTRODUCTION

As the EV market has grown, so has the market for EV chargers. Unfortunately, due to the need to quickly get EV chargers to market, little attention has been paid to making these products more convenient for users.

This is particularly true of the apparatus used to hold the connector or gun that connects the EV charger to an EV when the connector or gun is not in use. This connector holder is conventionally, for example, a simple short piece of plastic pipe into which the connector is inserted.

The connector holder is designed to hold the connector in place without making an electrical connection and to protect or shield the electrodes of the connector. To do this, the connector holder typically uses the same locking mechanism used to secure the connector to an EV. Unfortunately, there are at least five different connector standards and, therefore, a similar number of different locking mechanisms.

In addition, providing a connector holder that simply mimics the connection to an EV does not take advantage of the differences in the purposes of the two types of connections. It also does not take advantage of the opportunity to improve the user experience by making the return to the EV charger more convenient for the user.

As a result, additional apparatus and methods are needed to improve the connector holder of an EV charger in order to address different types of connectors, to take advantage of the purpose of the connector holder, and to improve the user experience.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is an exemplary exploded view of an EV charger connector holder showing a first removable socket plug on the right-hand side and an optional removable opening cover plug on the left-hand side, in accordance with various embodiments.

FIG. 2 is an exemplary assembled view of an EV charger connector holder showing a first removable socket plug on the right-hand side and an optional removable opening cover plug on the left-hand side, in accordance with various embodiments.

FIG. 3 is an exemplary assembled view of an EV charger connector holder showing a first removable socket plug on the right-hand side, a first type of electrical connector inserted into the first removable socket plug, and an optional removable opening cover plug on the left-hand side, in accordance with various embodiments.

FIG. 4 is an exemplary exploded view of an EV charger connector holder showing a first removable socket plug on the left-hand side and an optional removable opening cover plug on the right-hand side, in accordance with various embodiments.

FIG. 5 is an exemplary assembled view of an EV charger connector holder showing a first removable socket plug on the left-hand side, a first type of electrical connector inserted into the first removable socket plug, and an optional removable opening cover plug on the right-hand side, in accordance with various embodiments.

FIG. 6 is an exemplary assembled view of an EV charger connector holder showing a first removable socket plug on the right-hand side and a second copy of the first removable socket plug on the left-hand side, in accordance with various embodiments.

FIG. 7 is an exemplary assembled view of an EV charger connector holder showing a first removable socket plug on the left-hand side, a first type of electrical connector inserted into the first removable socket plug, a second copy of the first removable socket plug on the right-hand side, and a second first type of electrical connector inserted into the second copy of the first removable socket on the right-hand side, in accordance with various embodiments.

FIG. 8 is an exemplary cross-sectional view of an EV charger connector holder showing a self-locking mechanism of a first removable socket plug applying pressure to a notch of a first type of electrical connector, in accordance with various embodiments.

FIG. 9 is an exemplary cross-sectional view with an inset of an EV charger connector holder showing a metal spring plate self-locking mechanism of a first removable socket plug, in accordance with various embodiments.

FIG. 10 is an exemplary cross-sectional view of an EV charger connector holder showing a ball and spring self-locking mechanism of a first removable socket plug, in accordance with various embodiments.

FIG. 11 is an exemplary cross-sectional view of an EV charger connector holder showing a plastic latch self-locking mechanism of a first removable socket plug, in accordance with various embodiments.

FIG. 12 is an exemplary exploded view of an EV charger connector holder showing a second removable socket plug on the right-hand side and an optional removable opening cover plug on the left-hand side, in accordance with various embodiments.

FIG. 13 is an exemplary exploded view of an EV charger connector holder showing a second removable socket plug on the left-hand side and an optional removable opening cover plug on the right-hand side, in accordance with various embodiments.

FIG. 14 is an exemplary cross-sectional view of an EV charger connector holder showing that the inside structure of a second removable socket plug is adapted to include a protruding structure, in accordance with various embodiments.

FIG. 15 is an exemplary cross-sectional view of an EV charger connector holder showing two holes for mounting the EV charger connector holder to a wall, in accordance with various embodiments.

FIG. 16 is a flowchart showing a method for installing a removable socket plug for holding a particular type of electrical vehicle EV charger connector in an EV charger connector holder, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

As described above, as the EV market has grown, so has the market for EV chargers. Unfortunately, due to the need to quickly get EV chargers to market, little attention has been paid to making these products more convenient for users.

This is particularly true of conventional connector holders of EV chargers. These connector holders are generally a simple short piece of plastic pipe into which the connector is inserted. Such connector holders do not allow for differences in the types of connectors and do not take advantage of the opportunity to improve the user experience by making the return to the EV charger more convenient for the user.

As a result, additional apparatus and methods are needed to improve the connector holder of an EV charger in order to take advantage of the purpose of the connector holder and to improve the user experience.

### Connector Holder of an EV Charger

In various embodiments, a connector holder of an EV charger includes at least two different ports or sockets for holding one or two connectors. The two different ports allow the EV charger connector to be inserted in either the left or right side of the connector holder. This is useful for spacing two separate connectors of an EV charger. For an EV charger with just one connector, this makes docking the connector more convenient for both right and left-handed users.

In various embodiments, the connector holder is limited to just one socket by simply attaching a decorative cover to one socket.

In various embodiments, the connector holder includes a self-locking mechanism that makes docking the connector independent of the latch mechanism on the connector. This self-locking mechanism can include, but is not limited to a metal spring plate design, a ball and spring design, or a plastic latch design.

Various embodiments include (1) A charger gun holder that allows the user to install the socket from either the left or right side to suit different spacing and handedness; (2) A changeable socket that is moved to different side by screw fixation; (3) A two-socket design on EV charger gun holder; (4) Self-locking mechanism with metal spring plate design; (5) Self-locking mechanism with ball and spring design; and (6) Self-locking mechanism with plastic latch design.

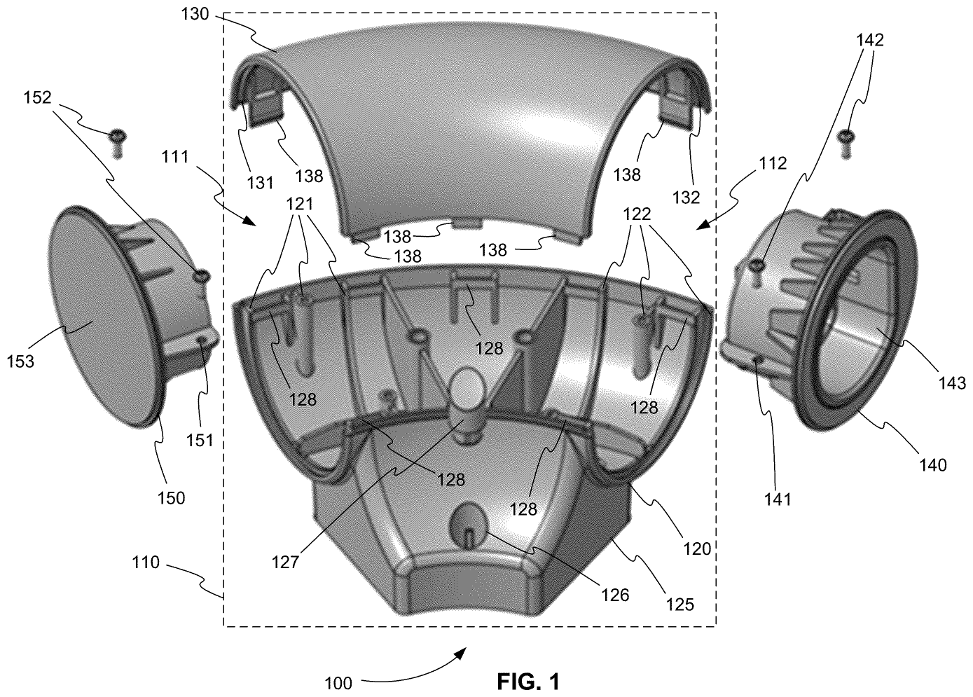

FIG. 1 is an exemplary exploded view 100 of an EV charger connector holder showing a first removable socket plug on the right-hand side and an optional removable opening cover plug on the left-hand side, in accordance with various embodiments. The EV charger connector holder includes housing 110 and first removable socket plug 140.

Housing 110 is shown detached into two parts in FIG. 1. These two parts include base 120 and cover 130. When base 120 and cover 130 are attached, housing 110 includes first opening 111 on a first side of housing 110 and second opening 112 on a second side of housing 110 opposite the first side. First opening 111 and second opening 112 are shown as circular openings. In various alternative embodiments, first opening 111 and second opening 112 can have a shape other than a circular shape. However, in order to accept interchangeable plugs, first opening 111 and second opening 112 have the same shape.

Base 120 includes base plate 125 adapted for fixing housing 110 to a wall (not shown), first base plug-holding structure 121, and second base plug-holding structure 122. In FIG. 1, base plate 125 includes hole 126 through which a wall fastener such as a screw can be placed. Decorative plug or cover 127 can be used to cover hole 126.

First base plug-holding structure 121 and second base plug-holding structure 122 each include ribs that form a shape for holding a plug and screw holes for fixating the plug. As shown in FIG. 1, the ribs form a half-cylinder shape for holding a cylindrical plug. As used herein a half-cylinder is a cylinder cut in half parallel to its length. In various alternative embodiments, first base plug-holding structure 121 and second base plug-holding structure 122 each include ribs that form a shape other than a half-cylinder shape. For example, the ribs can form a half-rectangular shape for holding a rectangular plug.

Cover 130 includes a corresponding first cover plug-holding structure 131 and corresponding second cover plug-holding structure 132. Although FIG. 1 only shows one rib of first cover plug-holding structure 131 and second cover plug-holding structure 132 that forms a shape for holding a plug, first cover plug-holding structure 131 and second cover plug-holding structure 132 can include multiple ribs.

As shown in FIG. 1, the ribs of cover 130 also form a half-cylinder shape for holding a cylindrical plug. In various alternative embodiments, first cover plug-holding structure 131 and second cover plug-holding structure 132 each include ribs that form a shape other than a half-cylinder shape. For example, the ribs can form a half-rectangular shape for holding a rectangular plug. Also, first cover plug-holding structure 131 and second cover plug-holding structure 132 can include screw holes in an alternative embodiment where the cylindrical plug is fixated to cover 130 rather than base 120.

When base 120 and cover 130 are attached, first base plug-holding structure 121 and first cover plug-holding structure 131 form a first housing port with first opening 111 at one end of the first housing port. Also, second base plug-holding structure 122 and second cover plug-holding structure 132 form a second housing port with second opening 112 at one end of the second housing port.

As shown in FIG. 1, base 120 includes first set of fasteners 128 and cover 130 includes second set of corresponding fasteners 138 for attaching cover 130 to base 120. In various embodiments, first set of fasteners 128 and second set of corresponding fasteners 138 are fasteners for attaching and detaching cover 130 and base 120 without tools. In various alternative embodiments, first set of fasteners 128 and second set of corresponding fasteners 138 are fasteners that do require tools for attaching and detaching cover 130 and base 120.

Using cover 130 and base 120 of FIG. 1, the first housing port and the second housing port have a cylindrical shape for accepting a cylindrically shaped plug. In various alternative embodiments, the first housing port and the second housing port can have a shape other than a cylindrical shape. For example, the first housing port and the second housing port can a rectangular shape. However, in order to accept interchangeable plugs, the first housing port and the second housing port have the same shape.

The EV charger connector holder of FIG. 1 further includes first removable socket plug 140. First removable socket plug 140 is an exemplary plug for holding a first type of electrical connector (not shown). First removable socket plug 140 includes an outside structure adapted for fixation to the first housing port or the second housing port of housing 110. For example, in FIG. 1, the outside structure of first removable socket plug 140 includes screw holes 141 for fixating first removable socket plug 140 to base 120 or cover 130 using screws 142.

The first type of electrical connector can be, but is not limited to, an EU (IEC 62196-2) Type 2 connector, a GB/T connector, a Tesla NACS (North American charging standard) connector, or a US (SAE J1772) Type 1 connector. As shown in FIG. 1, first removable socket plug 140 is designed for an EU (IEC 62196-2) Type 2 connector.

As shown in FIG. 1, base 120 includes screw holes of first base plug-holding structure 121 and second base plug-holding structure 122 for fixating first removable socket plug 140 to base 120 with screws 142. However, in various alternative embodiments, first removable socket plug 140 can be fixated to cover 130. Because cover 130 and base 120 can be detached, there is no need to fixate first removable socket plug 140 to both cover 130 and base 120.

More specifically, in one embodiment, base 120 includes one or more screw holes in first base plug-holding structure 121 and one or more screw holes in second base plug-holding structure 122 for fixating first removable socket plug 140 to the first housing port or the second housing port with screws. In an alternative embodiment, cover 130 includes one or more screw holes in first cover plug-holding structure 131 and one or more screw holes in second cover plug-holding structure 132 for fixating first removable socket plug 140 to the first housing port or the second housing port with screws.

Also, using screws and screw holes is just one way of fixating first removable socket plug 140 to base 120 or cover 130. In various alternative embodiments, any type of fastener can be used including fasteners that do not require tools.

First removable socket plug 140 includes inside structure 143 adapted for receiving and locking to the first type of electrical connector. Therefore, when first removable socket plug 140 is fixated to cover 130 or base 120 and cover 130 and base 120 are attached, housing 110 can hold the first type of electrical connector when it is inserted into inside structure 143.

In various embodiments, the EV charger connector holder of FIG. 1 further includes removable opening cover plug 150. Removable opening cover plug 150 is used to cover or shield a port of housing 110 not being used. Removable opening cover plug 150 includes an outside structure adapted for fixation to the first housing port or the second housing port of housing 110. For example, in FIG. 1, the outside structure of removable opening cover plug 150 includes screw holes 151 for fixating removable opening cover plug 150 to base 120 or cover 130 using screws 152.

As shown in FIG. 1, base 120 includes screw holes of first base plug-holding structure 121 and second base plug-holding structure 122 for fixating removable opening cover plug 150 to base 120 with screws 152. However, in various alternative embodiments, removable opening cover plug 150 can be fixated to cover 130.

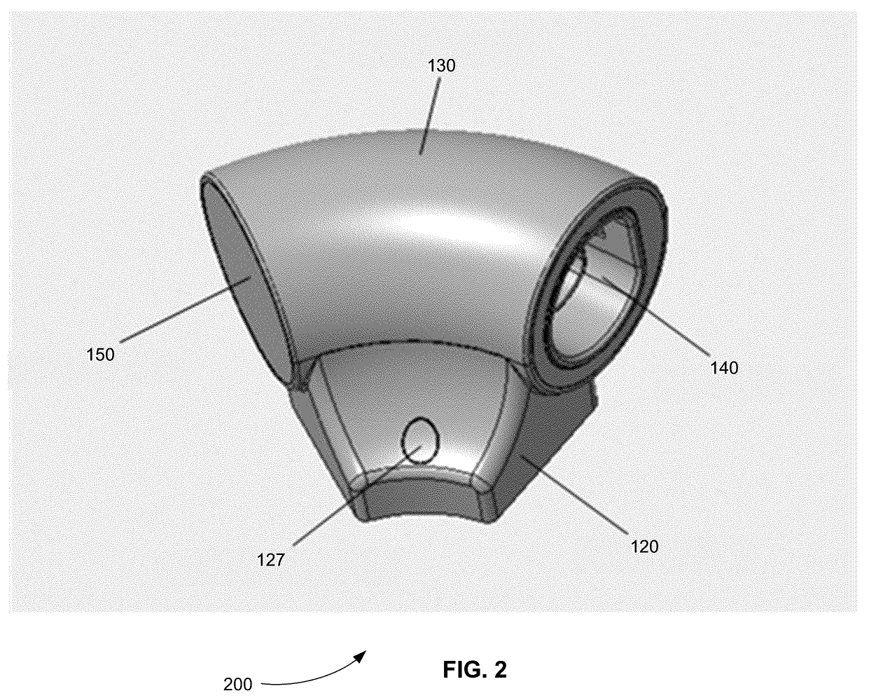

FIG. 2 is an exemplary assembled view 200 of an EV charger connector holder showing a first removable socket plug on the right-hand side and an optional removable opening cover plug on the left-hand side, in accordance with various embodiments. The assembled EV charger connector holder includes cover 130 attached to base 120. First removable socket plug 140 is installed in the second housing port and optional removable opening cover plug 150 is installed in the first housing port. Decorative plug or cover 127 covers or shields the hole in base 120 used to fixate base 120 to the wall. A first type of electrical connector is held by the EV charger connector holder by inserting it into first removable socket plug 140 and locking it there used a locking mechanism designed for the first type of electrical connector.

Due to the outer cylindrical shape of first removable socket plug 140 and outer cylindrical shape of optional removable opening cover plug 150, attached cover 130 and base 120 also form a cylindrical shape. More specifically, attached cover 130 and base 120 form a curved cylindrical shape or section of a torus, where each end of the cylindrical shape or section of a torus includes a housing port.

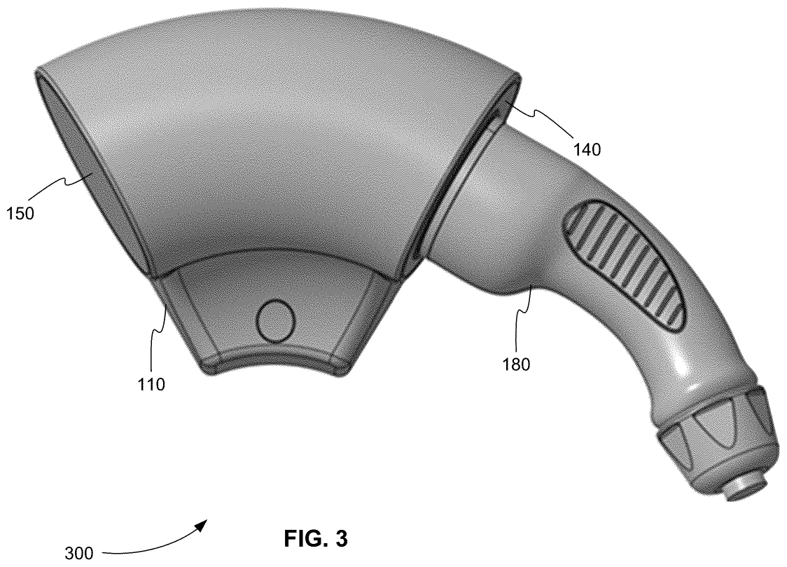

FIG. 3 is an exemplary assembled view 300 of an EV charger connector holder showing a first removable socket plug on the right-hand side, a first type of electrical connector inserted into the first removable socket plug, and an optional removable opening cover plug on the left-hand side, in accordance with various embodiments. As in FIG. 2, first removable socket plug 140 is installed in the second housing port of housing 110, and optional removable opening cover plug 150 is installed in the first housing port of housing 110. First type of electrical connector 180 is then inserted into first removable socket plug 140.

FIG. 3 shows the configuration of first removable socket plug 140 and optional removable opening cover plug 150 for holding first type of electrical connector 180 on the right-hand side of housing 110. In various embodiments, the locations of first removable socket plug 140 and optional removable opening cover plug 150 in housing 110 are interchanged or swapped in order to hold first type of electrical connector 180 on the left-hand side of housing 110.

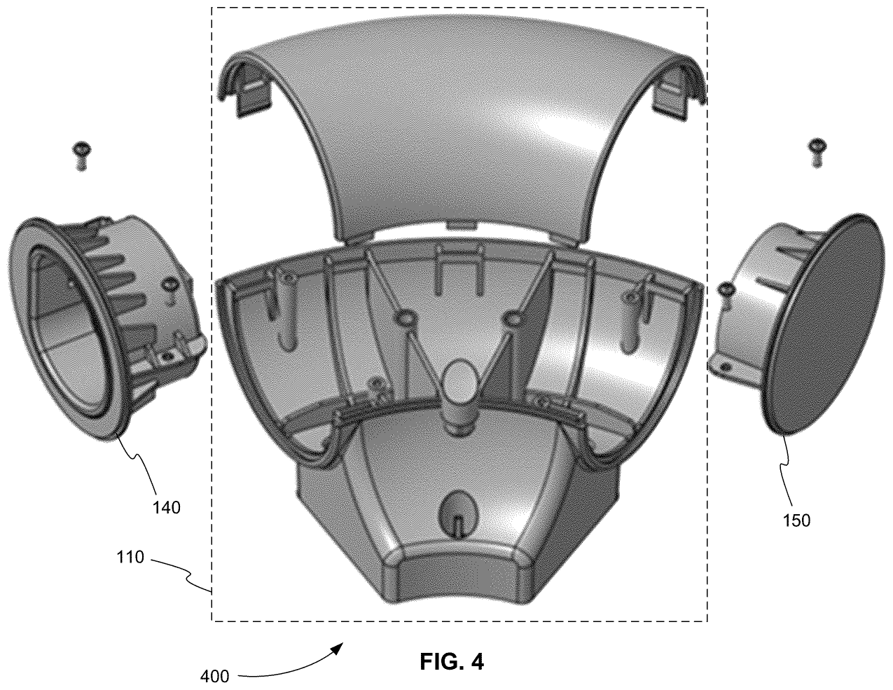

FIG. 4 is an exemplary exploded view 400 of an EV charger connector holder showing a first removable socket plug on the left-hand side and an optional removable opening cover plug on the right-hand side, in accordance with various embodiments. In comparison with FIG. 1, the locations of first removable socket plug 140 and optional removable opening cover plug 150 with respect to housing 110 are interchanged or swapped. First removable socket plug 140 is now on the left-hand side and optional removable opening cover plug 150 is on the right-hand side.

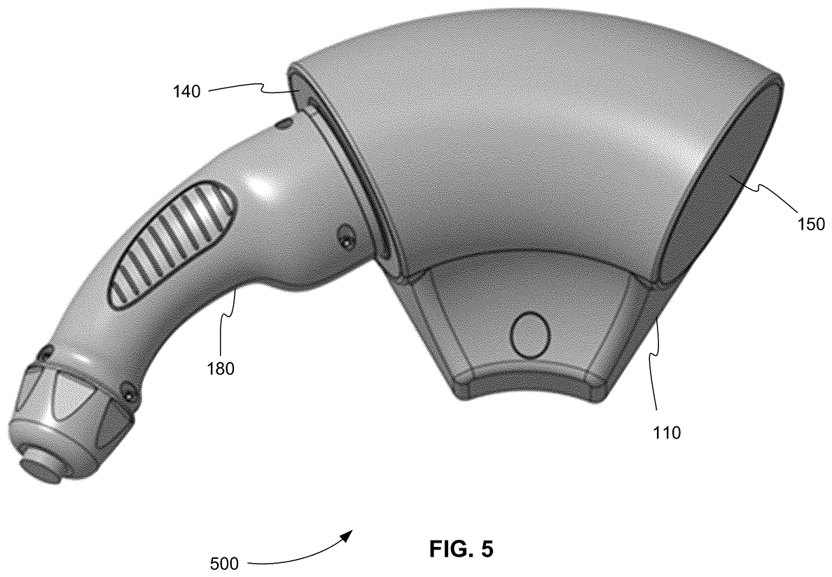

FIG. 5 is an exemplary assembled view 500 of an EV charger connector holder showing a first removable socket plug on the left-hand side, a first type of electrical connector inserted into the first removable socket plug, and an optional removable opening cover plug on the right-hand side, in accordance with various embodiments. First removable socket plug 140 is installed in the first housing port of housing 110 and optional removable opening cover plug 150 is installed in the second housing port of housing 110. First type of electrical connector 180 is then inserted into first removable socket plug 140. Together, FIGS. 3 and 5 show how interchanging the locations of first housing removable socket plug 140 and optional removable opening cover plug 150 allow first type of electrical connector 180 to be placed on either side of the housing 110.

In various embodiments, housing 110 is configured to hold two EV charger connectors. This is done by replacing optional removable opening cover plug 150 with a second copy of first housing removable socket plug 140.

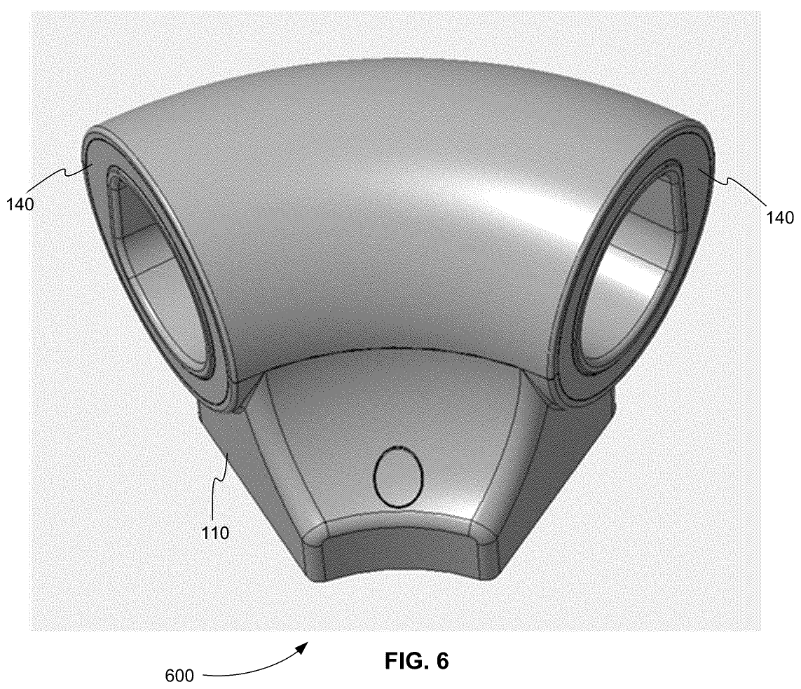

FIG. 6 is an exemplary assembled view 600 of an EV charger connector holder showing a first removable socket plug on the right-hand side and a second copy of the first removable socket plug on the left-hand side, in accordance with various embodiments. First removable socket plug 140 is installed in the first housing port of housing 110 and second copy of first removable socket plug 140 is installed in the second housing port of housing 110. This allows two first type of electrical connectors to be held by housing 110. This is useful, for example, when an EV charger is capable of charging two cars at the same time. It can also simply be more convenient for charging just one car by allowing a user to choose the most accessible connector at any particular time.

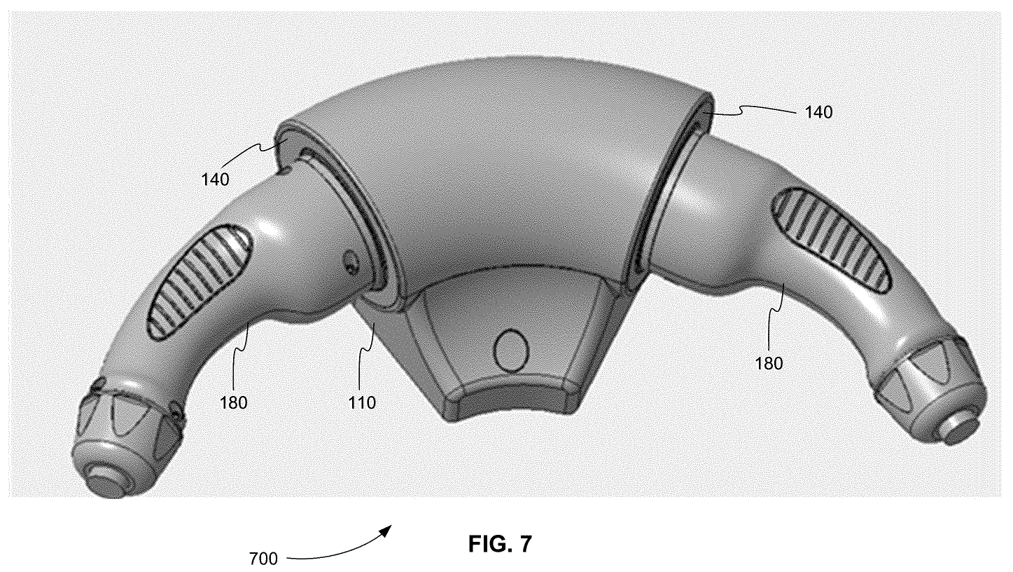

FIG. 7 is an exemplary assembled view 700 of an EV charger connector holder showing a first removable socket plug on the left-hand side, a first type of electrical connector inserted into the first removable socket plug, a second copy of the first removable socket plug on the right-hand side, and a second copy of the first type of electrical connector inserted into the second copy of the first removable socket on the right-hand side, in accordance with various embodiments. A first removable socket plug 140 is installed in each of the first and second housing ports of housing 110. This allows two of first type of electrical connector 180 to be inserted into and locked by housing 110.

As described above, first type of electrical connector 180 can be, but is not limited to, an EU (IEC 62196-2) Type 2 connector, a GB/T connector, a Tesla NACS (North American charging standard) connector, or a US (SAE J1772) Type 1 connector. As shown in FIG. 7, first removable socket plug 140 is designed for an EU (IEC 62196-2) Type 2 connector.

In various embodiments, the inside structure of first removable socket plug 140 is adapted with a first self-locking mechanism to apply pressure to a notch of first type of electrical connector 180 to hold first type of electrical connector 180 in first removable socket plug 140.

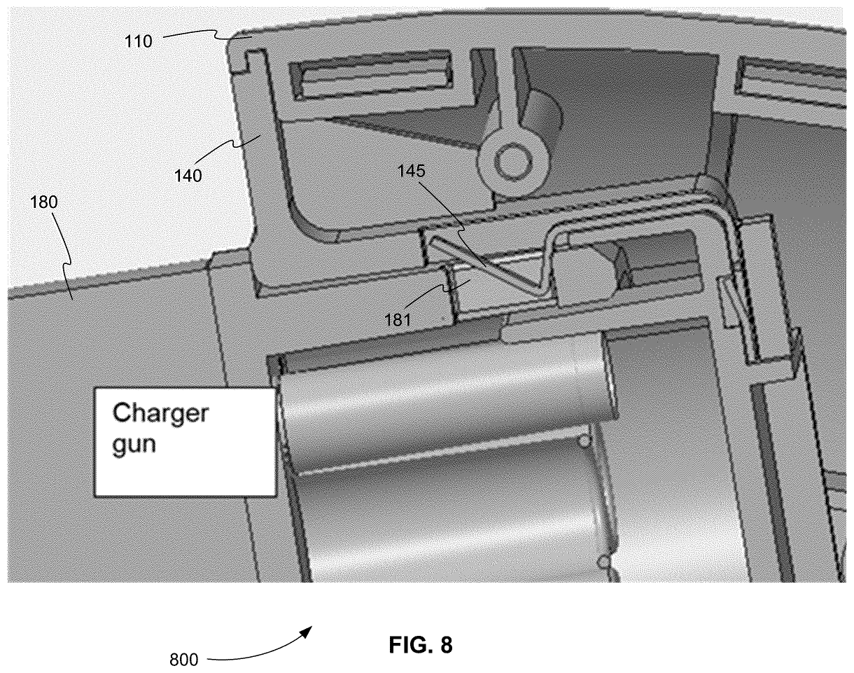

FIG. 8 is an exemplary cross-sectional view 800 of an EV charger connector holder showing a self-locking mechanism of a first removable socket plug applying pressure to a notch of a first type of electrical connector, in accordance with various embodiments. FIG. 8 shows first type of electrical connector 180 inserted into first removable socket plug 140 of housing 110. First removable socket plug 140 includes self-locking mechanism 145. Self-locking mechanism 145 applies pressure to notch 181 of first type of electrical connector 180 to hold first type of electrical connector 180 in first removable socket plug 140. In various embodiments, self-locking mechanism 145 is one of a metal spring plate, a spring and ball, or a plastic latch.

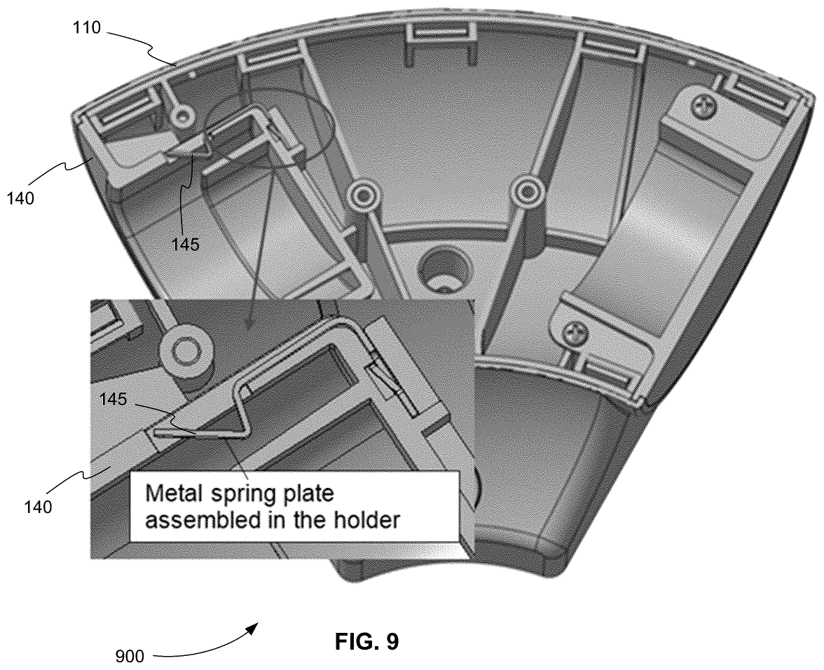

FIG. 9 is an exemplary cross-sectional view with inset 900 of an EV charger connector holder showing a metal spring plate self-locking mechanism of a first removable socket plug, in accordance with various embodiments. FIG. 9 shows first removable socket plug 140 of housing 110. Self-locking mechanism 145 of first removable socket plug 140 is a metal spring plate.

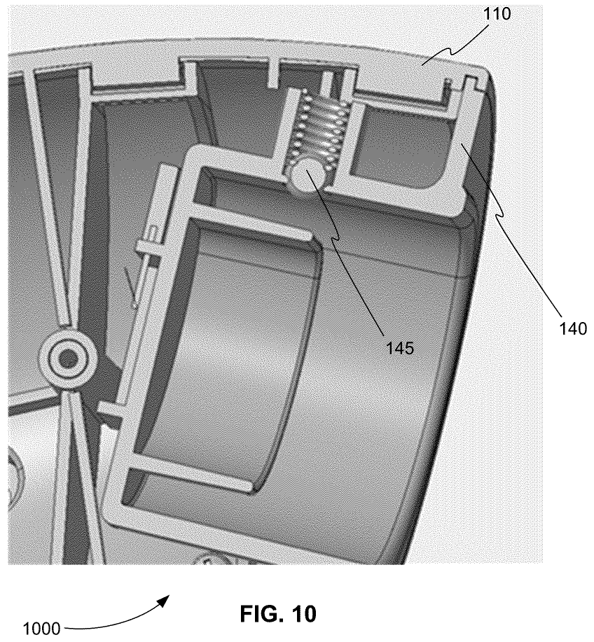

FIG. 10 is an exemplary cross-sectional view 1000 of an EV charger connector holder showing a ball and spring self-locking mechanism of a first removable socket plug, in accordance with various embodiments. FIG. 10 shows first removable socket plug 140 of housing 110. Self-locking mechanism 145 of first removable socket plug 140 is a ball and spring.

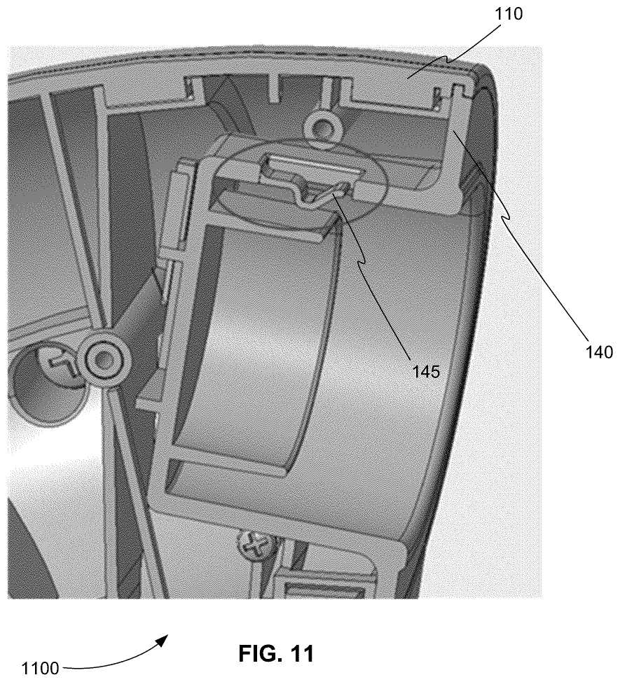

FIG. 11 is an exemplary cross-sectional view 1100 of an EV charger connector holder showing a plastic latch self-locking mechanism of a first removable socket plug, in accordance with various embodiments. FIG. 11 shows first removable socket plug 140 of housing 110. Self-locking mechanism 145 of first removable socket plug 140 is a plastic latch.

FIG. 1 shows that an EV charger connector holder can include first removable socket plug 140 and optionally removable opening cover plug 150. FIG. 4 shows that the locations of first removable socket plug 140 and optional removable opening cover plug 150 are interchangeable. FIG. 7 shows that optional removable opening cover plug 150 can be replaced with a second copy of first removable socket plug 140 allowing housing 110 to hold two of first type of electrical connecter 180.

In various embodiments, an EV charger connector holder further includes a second removable socket plug. The second removable socket plug is adapted to hold a second type of electrical connector that is not the same type as the first type of electrical connector. The second removable socket plug has an outside structure adapted for fixation to the first housing port or the second housing port. The second removable socket plug also has an inside structure adapted for receiving and locking to a second type of electrical connector. The second type of electrical connector can be, but is not limited to, an EU (IEC 62196-2) Type 2 connector, a GB/T connector, a Tesla NACS (North American charging standard) connector or a US (SAE J1772) Type 1 connector.

In various embodiments, an EV charger connector holder can include two second removable socket plugs. For example, the two first removable socket plugs 140 shown in FIG. 6 are replaced with two second removable socket plugs (not shown).

In various alternative embodiments, an EV charger connector holder includes a second removable socket plug in either the first housing port or the second housing port of the EV charger connector holder. Optionally, the EV charger connector holder can also include a removable opening cover plug in the port not occupied by the second removable socket plug.

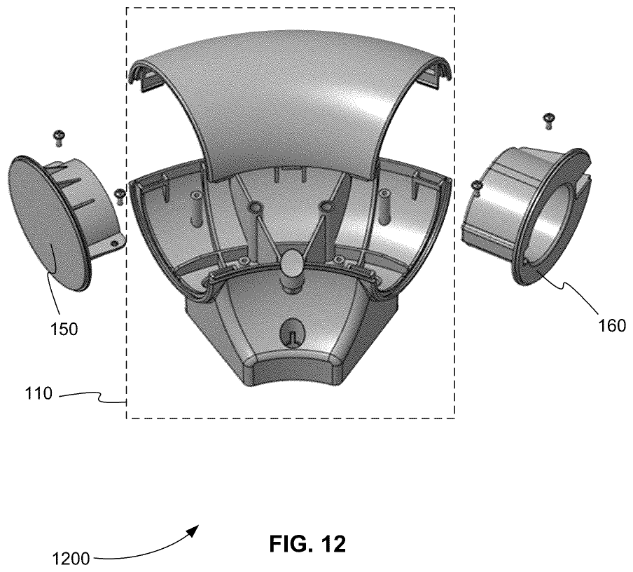

FIG. 12 is an exemplary exploded view 1200 of an EV charger connector holder showing a second removable socket plug on the right-hand side and an optional removable opening cover plug on the left-hand side, in accordance with various embodiments. The EV charger connector holder includes housing 110 and second removable socket plug 160. In various embodiments, the EV charger connector holder further includes optional removable opening cover plug 150. In various embodiments, the locations of second removable socket plug 160 and optional removable opening cover plug 150 with respect to housing 110 are interchanged.

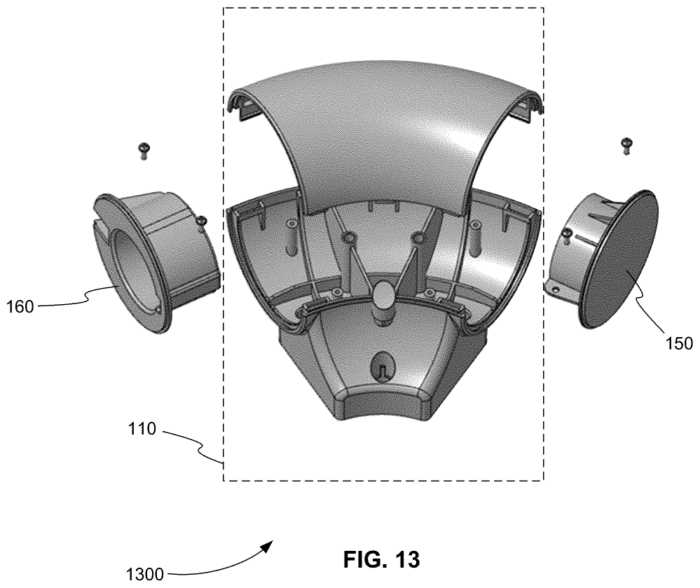

FIG. 13 is an exemplary exploded view 1300 of an EV charger connector holder showing a second removable socket plug on the left-hand side and an optional removable opening cover plug on the right-hand side, in accordance with various embodiments. In comparison with FIG. 12, the locations of second removable socket plug 160 and optional removable opening cover plug 150 with respect to housing 110 are interchanged or swapped. Second removable socket plug 160 is now on the left-hand side and optional removable opening cover plug 150 is on the right-hand side.

In FIGS. 12 and 13, second removable socket plug 160 is shown as adapted to hold and lock a US (SAE J1772) Type 1 connector. This connector includes a latch on top of the connector for locking the connector to a car or connector holder. As a result, in various embodiments, the inside structure of second removable socket plug 160 is adapted to include a protruding structure that receives a latch of the second type of electrical connector to hold the second type of electrical connector in second removable socket plug 160.

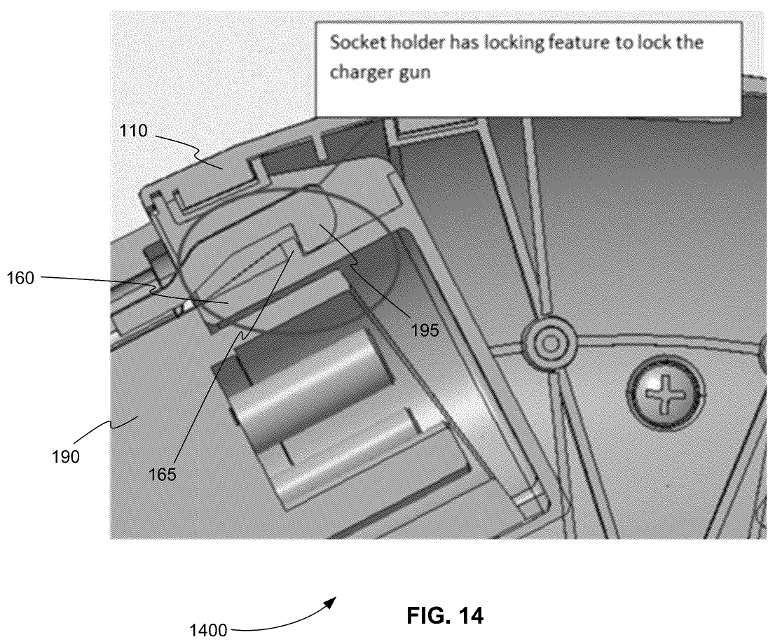

FIG. 14 is an exemplary cross-sectional view 1400 of an EV charger connector holder showing that the inside structure of a second removable socket plug is adapted to include a protruding structure, in accordance with various embodiments. FIG. 14 shows second type of electrical connector 190 inserted into second removable socket plug 160 of housing 110. Second type of electrical connector 190 includes latch 195. Second removable socket plug 160 includes protruding structure 165 to latch 195 of second type of electrical connector 190 to hold second type of electrical connector 190 in second removable socket plug 160.

Although in FIGS. 12 and 13 second removable socket plug 160 is shown as adapted to hold and lock a US (SAE J1772) Type 1 connector, second removable socket plug 160 is not limited to being adapted to accept this type of connector. Second removable socket plug 160 can be adapted to accept any type of connector, just not the same connector as the first removable socket plug.

Similarly, although in FIGS. 1-11 first removable socket plug 140 is shown as adapted to hold and lock an EU (IEC 62196-2) Type 2 connector, second socket plug 160 is not limited to being adapted to accept this type of connector. First removable socket plug 140 can be adapted to accept any type of connector, just not the same connector as the second removable socket plug.

Finally, FIG. 1 shows a hole 126 through which a wall fastener such as a screw can be placed to secure an EV charger connector holder to a wall. In various embodiments, the EV charger connector holder includes two or more screw holes for securing the EV charger connector holder to a wall.

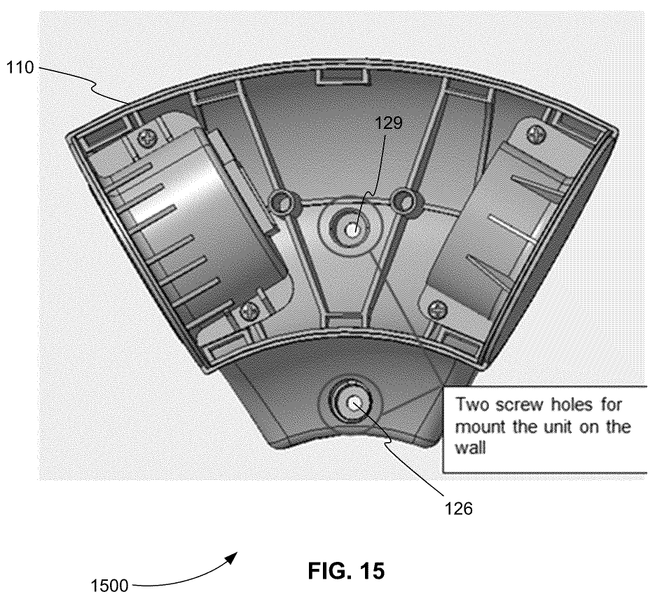

FIG. 15 is an exemplary cross-sectional view 1500 of an EV charger connector holder showing two holes for mounting the EV charger connector holder to a wall, in accordance with various embodiments. In FIG. 15, base 120 of the EV charger connector holder includes two holes 126 and 129 for securing base 120 to a wall.

### Method for Correcting a Retention Time

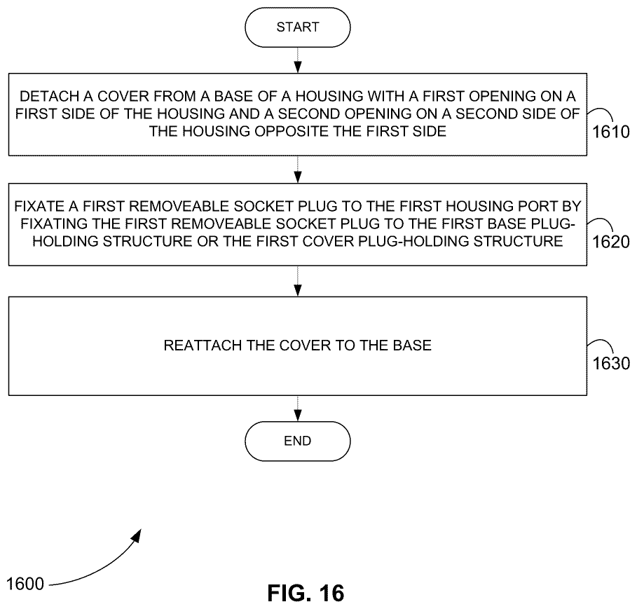

FIG. 16 is a flowchart showing a method 1600 for installing a removable socket plug for holding a particular type of electrical vehicle EV charger connector in an EV charger connector holder, in accordance with various embodiments.

In step 1610 of method 1600, a cover is detached from a base of a housing with a first opening on a first side of the housing and a second opening on a second side of the housing opposite the first side. The base includes a base plate adapted for fixing the housing to a wall, a first base plug-holding structure, and a second base plug-holding structure. The cover includes a first cover plug-holding structure and a second cover plug-holding structure. When the base and the cover are attached, the first base plug-holding structure and the first cover plug-holding structure form a first housing port with the first opening at one end and the second base plug-holding structure and the second cover plug-holding structure form a second housing port with the second opening at one end.

In step 1620, a first removable socket plug is fixated to the first housing port by fixating the first removable socket plug to the first base plug-holding structure or the first cover plug-holding structure. The first removable socket plug includes an outside structure adapted for fixation to the first housing port or the second housing port and an inside structure adapted for receiving and locking to a first type of electrical connector

In step 1630, the cover is reattached to the base.

In various embodiments, a removable opening cover plug can also be installed with the first removable socket plug. For example, before step 1630, a removable opening cover plug is fixated to the second housing port by fixating the removable opening cover plug to the second base plug-holding structure or the second cover plug-holding structure. The removable opening cover plug includes an outside structure adapted for fixation to the first housing port or the second housing port and a circular plate at one end of the removable opening cover plug adapted for covering the first opening or the second opening when the base and the cover are attached.

In various embodiments, a second removable socket plug is removed before the first removable socket plug is installed. For example, before step 1620, a fixated second removable socket plug is removed from the first housing port by removing the second removable socket plug from the first base plug-holding structure or the first cover plug-holding structure. The second removable socket plug includes an outside structure adapted for fixation to the first housing port or the second housing port and an inside structure adapted for receiving and locking to a second type of electrical connector.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. Similarly, though the described application used MRM as a detection technique, the described method can be applied to any targeted analysis for MS/MS analysis such as MRM3, single ion monitoring (SIM) or even targeted product ion scan (TOF-MS). In addition, the claims directed to the method and/or process should not be limited to the performance of their steps in the order written, and one skilled in the art can readily appreciate that the sequences may be varied and still remain within the spirit and scope of the various embodiments.

What is claimed is:

1. An electrical vehicle (EV) charger connector holder, comprising:
a housing that includes a base and a cover with a first opening on a first side of the housing and a second opening on a second side of the housing opposite the first side, wherein
the base includes a base plate adapted for fixing the housing to a wall, a first base plug-holding structure, and a second base plug-holding structure,
the cover includes a first cover plug-holding structure and a second cover plug-holding structure, and
when the base and the cover are attached, the first base plug-holding structure and the first cover plug-holding structure form a first housing port with the first opening at one end and the second base plug-holding structure and the second cover plug-holding structure form a second housing port with the second opening at one end; and
a first removable socket plug with
an outside structure adapted for fixation to the first housing port or the second housing port, and
an inside structure adapted for receiving and locking to a first type of electrical connector.

2. The EV charger connector holder of claim 1, further comprising a first set of fasteners in the base and a second set of corresponding fasteners in the cover for attaching and detaching the cover and the base without tools.

3. The EV charger connector holder of claim 1, further comprising
one or more screw holes in the first base plug-holding structure and one or more screw holes in the second base plug-holding structure for fixating the first removable socket plug to the first housing port or the second housing port with screws or
one or more screw holes in the first cover plug-holding structure and one or more screw holes in the second cover plug-holding structure for fixating the first removable socket plug to the first housing port or the second housing port with screws.

4. The EV charger connector holder of claim 1, further comprising two or more screw holes in the base for securing the housing to a wall.

5. The EV charger connector holder of claim 1, further comprising a removable opening cover plug with
an outside structure adapted for fixation to the first housing port or the second housing port, and
a circular plate at one end of the removable opening cover plug adapted for covering the first opening or the second opening when the base and the cover are attached.

6. The EV charger connector holder of claim 1, wherein the first type of electrical connector comprises one of an EU (IEC 62196-2) Type 2 connector, a GB/T connector, a Tesla NACS (North American charging standard) connector and a US (SAE J1772) Type 1 connector.

7. The EV charger connector holder of claim 1, wherein the inside structure of the first removable socket plug is adapted with a first self-locking mechanism to apply pressure to a notch of the first type of electrical connector to hold the first type of electrical connector in the first removable socket plug.

8. The EV charger connector holder of claim 7, wherein the first self-locking mechanism comprises one of a metal spring plate, a spring and ball, or a plastic latch.

9. The EV charger connector holder of claim 1, wherein the inside structure of the first removable socket plug is adapted to include a protruding structure that receives a latch of the first type of electrical connector to hold the first type of electrical connector in the first removable socket plug.

10. The EV charger connector holder of claim 1, further comprising a second copy of the first removable socket plug.

11. The EV charger connector holder of claim 1, further comprising a second removable socket plug with
an outside structure adapted for fixation to the first housing port or the second housing port, and
an inside structure adapted for receiving and locking to a second type of electrical connector.

12. The EV charger connector holder of claim 11, wherein the second type of electrical connector comprises one of an EU (IEC 62196-2) Type 2 connector, a GB/T connector, a Tesla NACS (North American charging standard) connector and a US (SAE J1772) Type 1 connector.

13. The EV charger connector holder of claim 11, wherein the inside structure of the second removable socket plug is adapted with a second self-locking mechanism to apply pressure to a notch of the second type of electrical connector to hold the second type of electrical connector in the second removable socket plug.

14. The EV charger connector holder of claim 11, wherein the second self-locking mechanism comprises one of a metal spring plate, a spring and ball, or a plastic latch.

15. The EV charger connector holder of claim 11, wherein the inside structure of the second removable socket plug is adapted to include a protruding structure that receives a latch of the second type of electrical connector to hold the second type of electrical connector in the second removable socket plug.

16. The EV charger connector holder of claim 11, further comprising a second copy of the second removable socket plug.

17. The EV charger connector holder of claim 1, wherein, when the base and the cover are attached the base and the cover form a section of a torus.

18. A method for installing a removable socket plug for holding a particular type of electrical vehicle (EV) charger connector in an EV charger connector holder, comprising:
(a) detaching a cover from a base of a housing with a first opening on a first side of the housing and a second opening on a second side of the housing opposite the first side, wherein
the base includes a base plate adapted for fixing the housing to a wall, a first base plug-holding structure, and a second base plug-holding structure,
the cover includes a first cover plug-holding structure and a second cover plug-holding structure, and
when the base and the cover are attached, the first base plug-holding structure and the first cover plug-holding structure form a first housing port with the first opening at one end and the second base plug-holding structure and the second cover plug-holding structure form a second housing port with the second opening at one end;
(b) fixating a first removable socket plug to the first housing port by fixating the first removable socket plug to the first base plug-holding structure or the first cover plug-holding structure, wherein the first removable socket plug includes an outside structure adapted for fixation to the first housing port or the second housing port and an inside structure adapted for receiving and locking to a first type of electrical connector; and
(c) reattaching the cover to the base.

19. The method of claim 18, further comprising before step (c)
fixating a removable opening cover plug to the second housing port by fixating the removable opening cover plug to the second base plug-holding structure or the second cover plug-holding structure, wherein the removable opening cover plug includes
an outside structure adapted for fixation to the first housing port or the second housing port; and
a circular plate at one end of the removable opening cover plug adapted for covering the first opening or the second opening when the base and the cover are attached.

20. The method of claim 18, further comprising before step (b)
removing a fixated second removable socket plug from the first housing port by removing the second removable socket plug from the first base plug-holding structure or the first cover plug-holding structure, wherein the second removable socket plug includes an outside structure adapted for fixation to the first housing port or the second housing port and an inside structure adapted for receiving and locking to a second type of electrical connector.
